(19) United States
(12) Patent Application Publication
(10) Pub. No.: US 2012/0158298 A1
(43) Pub. Date: Jun. 21, 2012

(54) AUTOMOBILE ROUTE SEARCH METHOD CONSIDERING LINEARITY OF ROUTE

(76) Inventor: Sung Jae BYUN, Daegu (KR)

(21) Appl. No.: 13/228,904

(22) Filed: Sep. 9, 2011

(30) Foreign Application Priority Data
Dec. 15, 2010 (KR) 10-2010-0128716

(51) Int. Cl. G01C 21/00

(52) U.S. Cl. 701/527

(57) ABSTRACT

A route search method considering the linearity of a route includes: once an arriving is inputted, searching a route to the arriving; when the searched routes are more than two, obtaining linear type information for each of the searched routes; and selecting one of the routes according to the linear type information.

### CROSS-REFERENCE TO RELATED APPLICATIONS

The present application claims priority to Korean patent application number 10-2010-0128716, filed on Dec. 15, 2010, which is incorporated by reference in its entirety.

### BACKGROUND OF THE INVENTION

The present invention relates to a navigation system, and more particularly, to an automobile route search method considering the linearity of a route.

Generally, a navigation system is a system providing travel information of a vehicle such as a car using a satellite and is also called an auto navigation system.

The navigation system receives predetermined information from a Global Positioning System (GPS) satellite above the earth through a GPS receiver, and calculates its position based on the received information. Next, based on its position information, the GPS receiver notifies the current location of a car to a user, calculates a rout to a desired arriving, guides a user along the route, so that various information helpful for driving is provided.

Diverse algorithms are invented for the navigation system to search a route and provide an optimal route. For example, a method for searching a route by circumventing a congested road or searching a route by passing through the minimum number of intersections is introduced.

The above technical configuration is just a background technique to help understanding the present invention and does not mean a conventional technique known to those skilled in the art.

### SUMMARY OF THE INVENTION

Embodiments of the present invention are directed to an automobile route search method considering the linearity of a route, which selects and guides one of routes based on linearity information for each route if the number of searched routes between departing and arriving is more than two.

Embodiments of the present invention are also directed to an automobile route search method considering the linearity of a route, which improves fuel efficiency, reduces driver's fatigue, and allows a vehicle to reach the arriving faster by selecting an optimal route based on linearity information of a road

In one embodiment, a route search method considering the linearity of a route includes: once an arriving is inputted, searching a route to the arriving; when the searched routes are more than two, obtaining linear type information for each of the searched routes; and selecting one of the routes according to the linear type information.

The linear type information may include plane linear type information and vertical linear type information.

The selecting of one of the routes may include selecting a route having a relatively large curve radius of the plane linear type information from the routes.

The selecting of one of the two routes may include selecting a route having a relatively small vertical slope of the vertical linear type information from the routes.

The obtaining of the linear type information for each of the searched routes may include: confirming an average travel time of the searched route; selecting a predetermined number of the routes from the searched routes in an order from the smallest to largest average travel time; and obtaining linear type information of the selected route.

### BRIEF DESCRIPTION OF THE DRAWINGS

FIG. 1 illustrates a block diagram of a route search device considering the linearity of a route according to one embodiment of the present invention.

FIG. 2 illustrates a route search method considering the linearity of a route according to one embodiment of the inventive concept.

FIG. 3 illustrates a view of an optimal route search considering the linearity of a route according to one embodiment of the inventive concept.

### DESCRIPTION OF SPECIFIC EMBODIMENTS

Hereinafter, an automobile route search method considering the linearity of a route in accordance with the present invention will be described in detail with reference to the accompanying drawings. In the drawings, the thicknesses of layers and regions are exaggerated for clarity. While the present invention has been particularly shown and described with reference to exemplary embodiments thereof, it will be understood by those of ordinary skill in the art that various changes in form and details may be made therein without departing from the spirit and scope of the present invention as defined by the following claims.

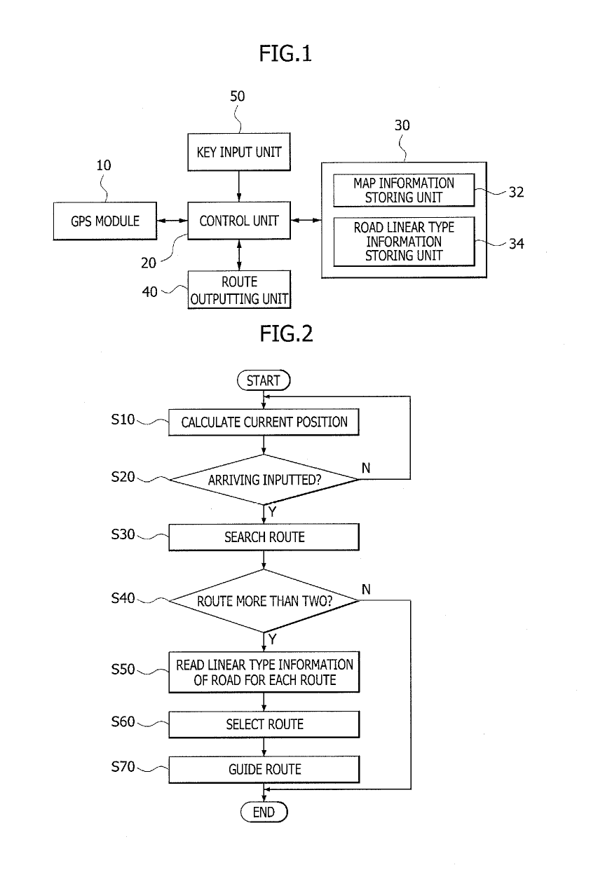

FIG. 1 illustrates a block diagram of a route search device considering the linearity of a route according to one embodiment of the present invention.

The route search device considering the linearity of a route according to one embodiment of the present invention searches an optimal route based on the linearity information of a road among more than two searched routes as a route search result and includes a Global Positioning System (GPS) module 10, a control unit 20, an information storing unit 30, a route outputting unit 40, and a key input unit 50.

Here, the road linearity is largely divided into a plane linear type, a vertical linear type, and a horizontal linear type. The plane linear type is an indicator representing a curve status of a road in a plane, the vertical linear type is an indicator representing the degree of slope that a road is slant in a progressing direction, and the horizontal linear type is an indicator representing the degree of slope that a rood is slant in a horizontal direction.

Especially, since the plane linear type represents a curve status of a road in a driving direction, as the number of curves is larger and its radius is smaller, the number of acceleration and deceleration is increased. As a result, fuel efficiency may be reduced and driver's fatigue may be increased.

Additionally, the vertical linear type represents a slope in a driving direction, if a road has a high slope, fuel efficiency may be reduced while driving.

Accordingly, the plane linear type and the vertical linear type may greatly affect vehicle driving. Therefore, according to the embodiment, the plane linear type and the vertical linear type among road linear types will be mainly described.

The GPS module 10 receives a position signal from a plurality of satellites and calculates its position using the position signal to input it to the control unit 20.

The information storing unit 30 includes a map information storing unit 32 for storing map information and a road type and average travel time of each route and a road linear type information storing unit 34 for linearity information of a road, for example, plane linear type and vertical linear type information.

The route outputting unit 40 outputs a selected optimal route. The route outputting unit 40 outputs an image having a route matched to a map and outputs a voice for driving guide at each position. Accordingly, a driver drives a car with a real-time route guide.

The key input unit 50 allows a user to input an arriving. The key input unit 50 includes arranged consonants and vowels of the Korean alphabet and the English alphabet to input an arriving and once one of them is inputted, a letter is completed by combining the inputted consonant and vowel.

The control unit 20 searches available routes to the arriving inputted by a user at a current position during route searching, from the map information. As a search result, if the searched routes are more than two, plane linear type information and vertical linear type information of each searched route are read from the road linear type information storing unit 34. Then, an optimal route is selected in consideration with an average travel time of each searched route with linear information of each route. In the above manner, once an optimal route is selected, a corresponding optimized route is outputted through the route outputting unit 40 to guide a route to the arriving.

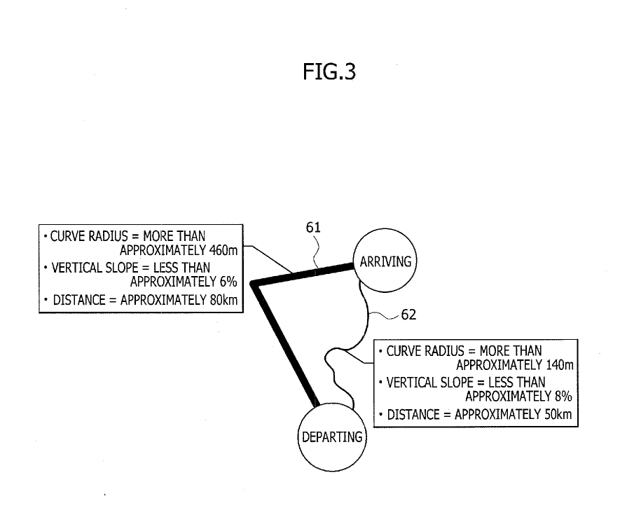

FIG. 2 illustrates a route search method considering the linearity of a route according to one embodiment of the inventive concept. FIG. 3 illustrates a view of an optimal route search considering the linearity of a route according to one embodiment of the inventive concept.

First, the GPS module 10 receives each position signal from a plurality of satellites and calculates a current position of itself through the received position signal in operation S10 and inputs it to the control unit 20.

Once a current position is inputted from the GPS module 10, the control unit 20 confirms that a driver inputs an arriving through the key input unit 50 in operation S20.

After confirming a result, when the arriving is inputted, after map information is read from the map information storing unit 32, the control unit 20 searches a route at the current position, i.e., a starting point, to the arriving using the map information in operation S30.

The control unit 20 confirms there are more than two routes between the departing and arriving based on a route search result in operation S40.

After confirming a result, if there is one route between the departing and the arriving, a searched corresponding route is mapped into map information and then outputted through the route outputting unit 40, so that a route from the departing to the arriving is guided with an image and a voice in operation S70.

Moreover, after confirming a result, if there are two routes between the departing and the arriving, linear type information of each route is read from the rood linear type information storing unit 34 in operation S50.

After the reading of the linear type information for each route, the control unit 20 considers the linear type information of each route in addition to an average travel time of each route to select an optimal route in operation S60.

In this case, the control unit 20 selects a route as an optimal route, where a curve radius of the plane linear type information is relatively larger or a vertical slope of the vertical linear type information is relatively smaller.

For example, a predetermined number, e.g., two, is selected in an order from the smallest to largest average travel time from among a plurality of routes, and by comparing linear type information of the selected routes, a route, where a curve radius of the plane linear type information is larger or the vertical slope of the vertical linear type information is smaller, is selected.

If two routes are selected as an example, when one of two routes has a larger curve radius of the plane linear type information and a smaller vertical slope of the vertical linear type information, one having a larger curve radius of the plane linear type information and a smaller vertical slope of the vertical linear type information is selected as an optimal route.

Next, when one of two routes has a larger curve radius of the plane linear type information and a larger vertical slope of the vertical linear type information, one having a larger vertical slope of the vertical linear type information than another one and a larger curve radius of the plane linear type information is selected as an optimal route. That is, the vertical linear type information is firstly applied to the optimal route selection compared to the plane linear type information.

However, the technical range of the present invention is not limited to the above embodiment and thus also includes a case that the plane linear type information is firstly considered before the vertical linear type information.

Moreover, if a difference of curve radii of the plane linear type information and a difference of vertical slopes of the vertical linear type information in two routes are within a predetermined setting range, a route having a less travel time is selected as an optimal route. In this case, if one of the plane linear type information and the vertical linear type information is beyond the predetermined setting range, an optimal route may be selected according to corresponding linear type information.

The above embodiment illustrates one example that an optimal route is selected considering the linear type information but the technical range of the present invention is not limited to the above embodiment and thus also includes various methods in which an optimal route is selected according to a difference of curve radii of the plane linear type information and a difference of vertical slopes of the vertical linear type information or sizes of their values.

Furthermore, as mentioned above, once an optimal route is selected, it is mapped into the map information to output it to the route outputting unit 40, so that an optimal route to the arriving is guided in real-time in operation S70.

As one example, as shown in FIG. 3, a case that a first route 61 and a second route 62 from the departing to the arriving are searched will be described.

The first route 61 has a curve radius of more than approximately 460 m, a vertical slope of less than approximately 6%, and a distance to the arrival of approximately 58 km.

The second route 62 has a curve radius of more than approximately 140 m, a vertical slope of less than approximately 8%, and a distance to the arrival of approximately 50 km.

Comparing these two routes, although the second route 62 has a less distance than the first route 61, the first route 61 has a larger curve radius and a smaller vertical slope in a road than the second route 62.

Accordingly, compared to the second route 62, the first route 61 may reduce driver's fatigue and may improve fuel efficiency.

Therefore, even if the second route 62 has a shorter distance to the arrival than the first route 61, the first route 61 is selected as an optimal route and is guided.

The present invention improves fuel efficiency, reduces driver's fatigue, and allows a vehicle to reach the arriving faster by selecting an optimal route based on linearity information of a road.

While the present invention has been described with respect to the specific embodiments, it will be apparent to those skilled in the art that various changes and modifications may be made without departing from the spirit and scope of the invention as defined in the following claims.

What is claimed is:

1. A route search method considering the linearity of a route, the method comprising:
once an arriving is inputted, searching a route to the arriving;
when the searched routes are more than two, obtaining linear type information for each of the searched routes; and
selecting one of the routes according to the linear type information.

2. The method of claim 1, wherein the linear type information comprises plane linear type information and vertical linear type information.

3. The method of claim 2, wherein the selecting of one of the routes comprises selecting a route having a relatively large curve radius of the plane linear type information from the routes.

4. The method of claim 2, wherein the selecting of one of the two routes comprises selecting a route having a relatively small vertical slope of the vertical linear type information from the routes.

5. The method of claim 1, wherein the obtaining of the linear type information for each of the searched routes comprises:
confirming an average travel time of the searched route;
selecting a predetermined number of the routes from the searched routes in an order from the smallest to largest average travel time; and
obtaining linear type information of the selected route.
